(19) United States
(12) Patent Application Publication
(10) Pub. No.: US 2011/0263157 A1
(43) Pub. Date: Oct. 27, 2011

(54) ELECTRICAL CONNECTOR GROUNDING PATH TO OUTER SHELL

(75) Inventor: JIAN-MING BU, Kunshan (CN)

(73) Assignee: HON HAI PRECISION INDUSTRY CO., LTD., New Taipei (TW)

(21) Appl. No.: 13/092,333

(22) Filed: Apr. 22, 2011

(30) Foreign Application Priority Data
Apr. 23, 2010 (CN) 201010154121.3

(51) Int. Cl. H01R 13/648; H01R 25/00

(52) U.S. Cl. 439/607.01; 439/650

(57) ABSTRACT

An electrical connector (100) comprising a housing (200) defining a front face and a first mating cavity recessed rearward from the front face for receiving a modular plug, an electronic module (400) mounted to the housing, a horizontal PCB (500) mounted under the electronic module, and an outer shell (500) shielding the electronic module and the housing. The electronic module has a first ground trace connects the outer shell through a first conductive trace (56) of the horizontal PCB (500).

### BACKGROUND OF THE INVENTION

1. Field of the Invention

The present invention relates to a modular jack, and particularly, to a grounding trace of the modular jack.

2. Description of Related Art

U.S. Pat. No. 6,729,906, issued to Simmon et al. on May 4, 2004, discloses an electrical connector having an electronic module (or modules), an outer shell and a light emitting device (or devices). The electronic module includes a vertical component (printed circuit) board and a separated decoupling capacitor and an electrical path is established from the capacitor through a grounding clip extending through a through-hole, where it is grounded through a trace on the board, on the one hand, and through an intermediate and a lower shields to the outer shell on the other hand. The light emitting device is located beside the electronic module or between adjacent modules.

U.S. Pat. No. 6,962,511, issued to Gutierrez et al. on Nov. 8, 2005, discloses an electrical connector having an electronic module, an outer shell and a light emitting device. Also disclosed are a vertical, primary component board and a secondary bottom board or substrate with perforations for lower conductors from the primary board to penetrate therethrough for mechanical stability and registration. The footprint of the light emitting device is located behind the electronic module and the light emitting device is disposed outside the outer shell. There is no disclosure about grounding path or trace from the electronic module to the outer shell. Disposing light emitting device inside an outer shell can be seen, for example, in U.S. Pat. No. 6,352,446.

An object of present invention is to provide an electrical connector having an electronic module, a light emitting device having footprint located behind the electronic module, and an outer shell covering outside of the light emitting device and the electronic module and electrically connecting the electronic module.

### SUMMARY OF THE INVENTION

An object of the present invention is to provide an electrical connector comprising a housing defining a front face and a first mating cavity recessed rearward from the front face for receiving a modular plug, an electronic module mounted to the housing, a horizontal PCB mounted under the electronic module, an outer shell shielding the electronic module and the housing. The electronic module has a first ground trace connects the outer shell through a first conductive trace of the horizontal PCB.

Still another object of the present invention is to provide an electrical connector comprising a housing defining a front face and a first mating cavity recessed rearward from the front face for receiving a modular plug, an electronic module mounted to the housing, a horizontal PCB mounted under the electronic module, an outer shell shielding the electronic module. The outer shell has a vertical rear wall and a tab extending downwardly there from, and the horizontal PCB having a protrusion portion electrically connecting the protrusion portion of the horizontal PCB.

Other objects, advantages and novel features of the invention will become more apparent from the following detailed description of a preferred embodiment when taken in conjunction with the accompanying drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical connector according to an embodiment of the present invention;

FIG. 2 is an exploded view of the electrical connector shown in FIG. 1;

FIG. 3 is a perspective view of the electronic modules and the horizontal PCB;

FIG. 4 is a back perspective view of the electrical connector shown in FIG. 1 with the housing is removed; and

FIG. 5 is a schematic of the electrical connector shown in FIG. 1

### DETAILED DESCRIPTION OF THE INVENTION

Reference will now be made to the drawing figures to describe the present invention in detail.

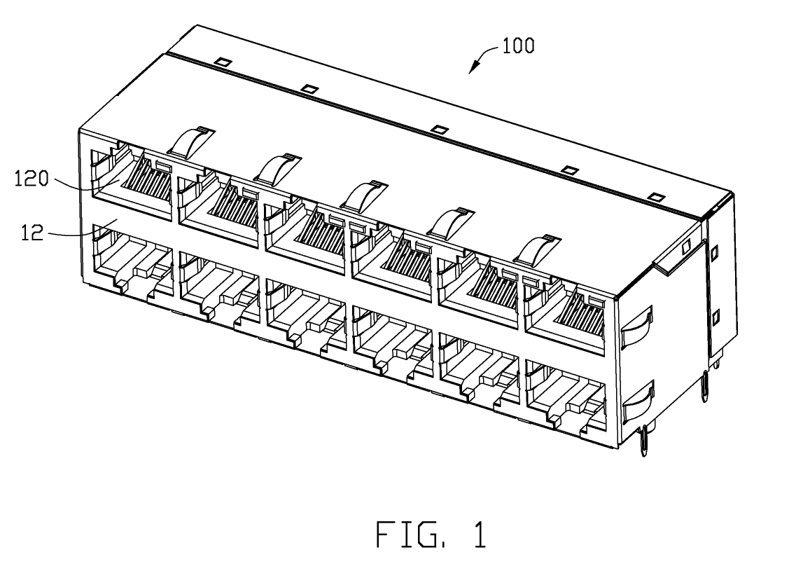

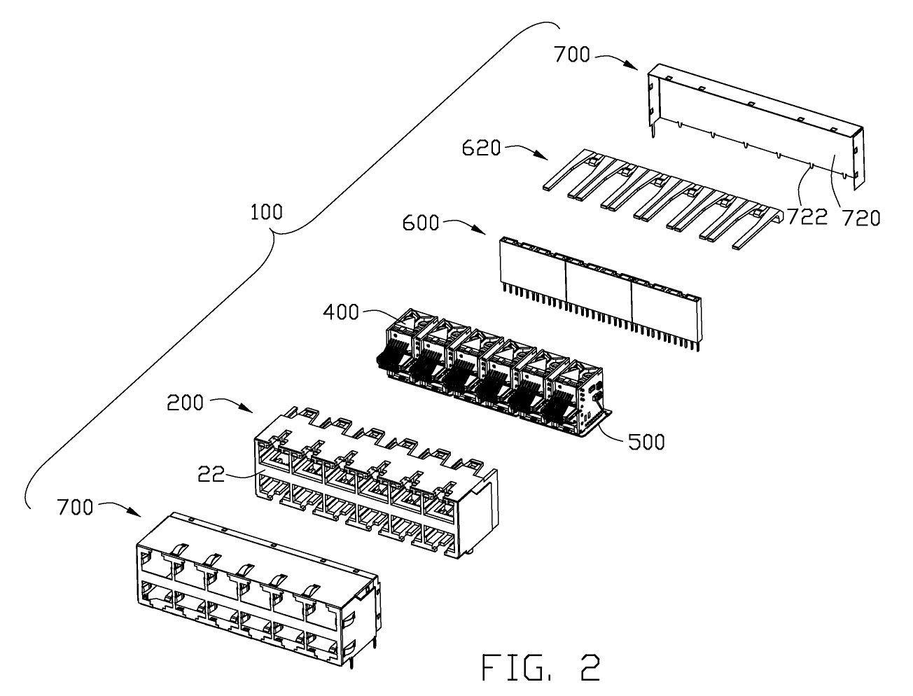

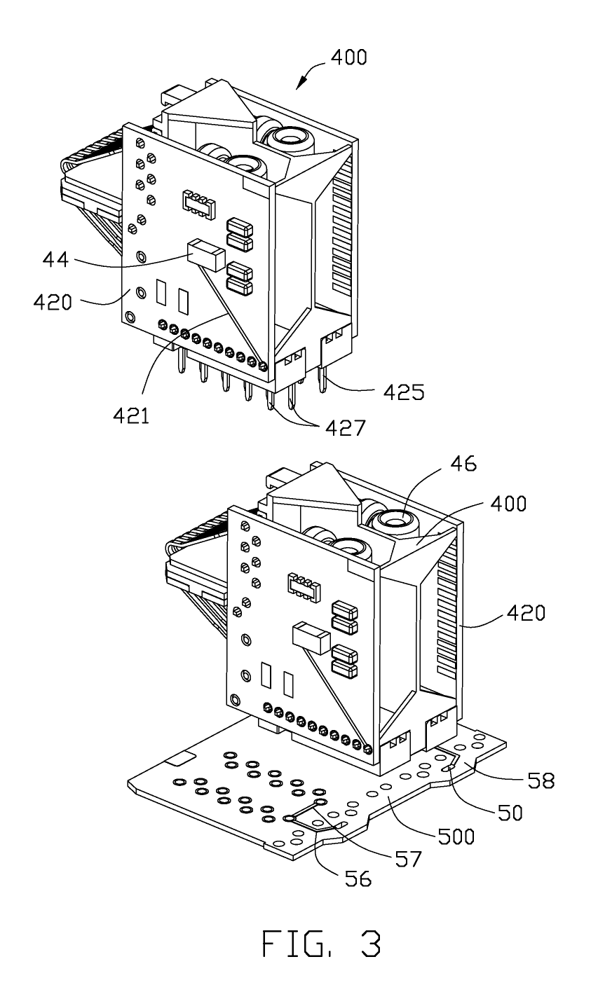

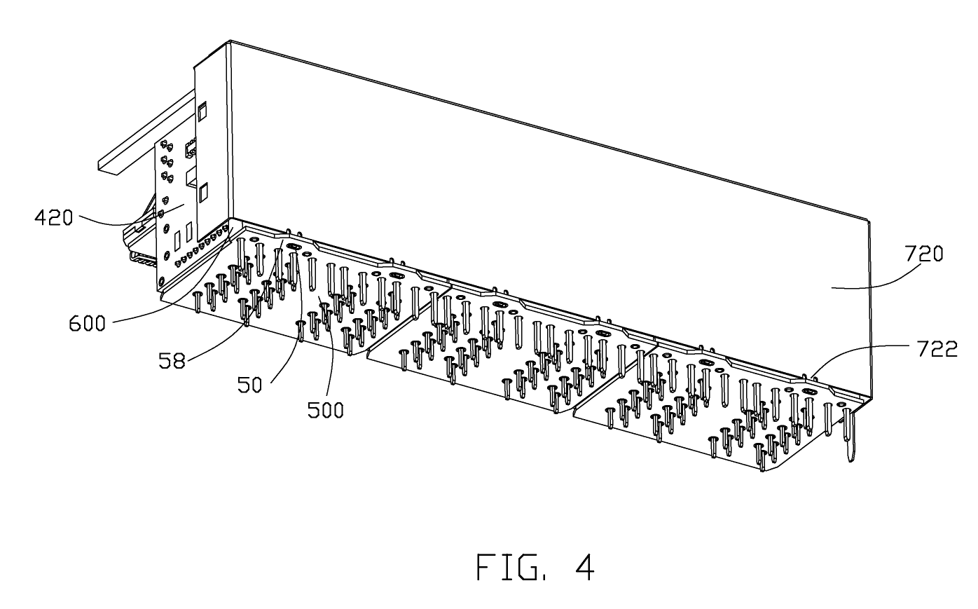

Referring to FIGS. 1-4, an electrical connector 100 of 2×N type modular jack is shown. The electrical connector 100 includes a housing 200, an electronic module 400 mounted to the housing 200, a bottom or horizontal PCB 500 mounted under the electronic module 400, an indicating device 600, 620, and an outer shell 700 covering the indicating device 600, 620, the electronic module 400, and the housing 200. The housing 200 defines a front face 22 and a first and a second rows of mating cavities recessed rearward from the front face 22 for receiving corresponding modular plugs (not shown). The first row of mating cavities are aligned with the second row of mating cavities one to one in a vertical direction. The electronic module 400 has a first and a second ground traces connect the outer shell 700 through a first and a second conductive traces 56, 57 of the horizontal PCB 500.

The electronic module 400 further includes a first and a second vertical PCBs 420 perpendicular to the front face; two groups of mating contacts respectively mounted on the first and the second vertical PCB 420 and extending into corresponding mating cavities; and two groups of conductors 425, 427 electrically connecting the vertical PCBs 420 and the horizontal PCB 500. The first ground trace includes a conductive trace 421 of the first vertical PCB 420 and one of said first plurality of conductors 427. The second ground trace includes a conductive trace 421 of the second vertical PCB 420 and one of the second group of conductors 425.

The horizontal PCB 500 defines a conductive through hole 50 electrically connecting the first conductive trace 56 of horizontal PCB 500. The outer shell 700 has a rear wall 720. The rear wall 720 forms a conductive pin 722 extending into the conductive through hole 50 and being electrically connected therein. The horizontal PCB 500 has a protrusion portion 58 extending rearward. The conductive through hole 50 is disposed in the protrusion 58 and aligned with the rear wall 720 of the outer shell 700 in the vertical direction.

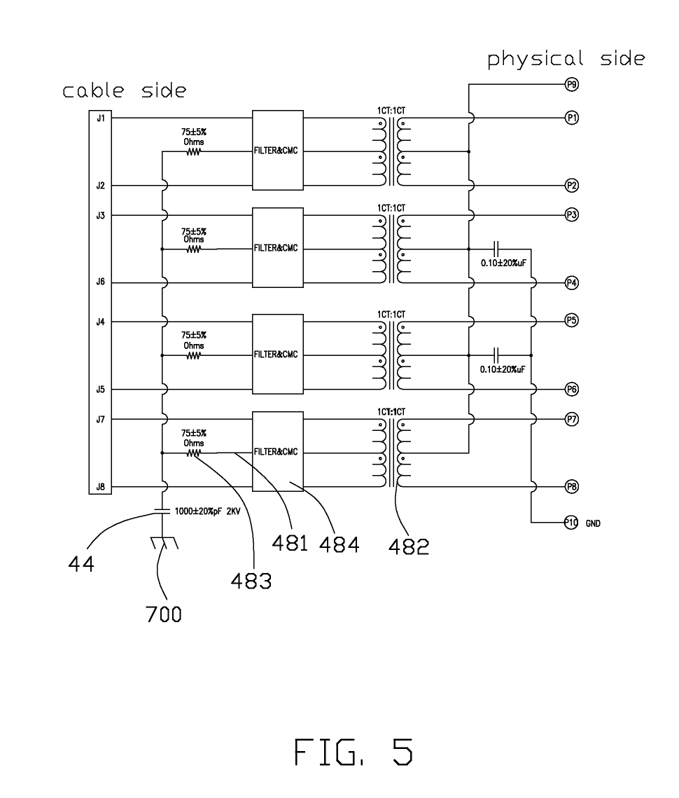

The electronic module 400 forms a plurality of signal channels (referring to FIG. 5), each signal channel having a parallely connected transformer 482 and a serially connected common mode choke 484 mounted on the first vertical PCB 420. The transformer 482 and the common mode choke 484 are connected between a physic side and a cable side in the electronic module 400. The common mode choke 484 has a center tap 481 electrically connected a common signal of the common mode choke 484. The electronic module 400 further comprises a resistor 483 of 75 OHMS and a capacitor 44. The resistor is serially and electrically connected between the common center tap of common mode choke and a pole of the capacitor 44. An opposite pole of the capacitor 44 is electrically connected to the conductive trace 421 of the first or the second vertical PCBs 420.

The electrical connector 100 further comprises an indicating device 600, 620. The indicating device 600, 620 includes a light emitting device 600 mounted behind the electronic module 400 and a light guiding pipe 620 mounted in the housing 200. The outer shell 700 covers outside of the housing 200, the electronic module 400 and the indicating device 600, 620.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
a housing defining a front face and a first mating cavity recessed rearward from the front face for receiving a modular plug;
an electronic module mounted to the housing;
a horizontal printed circuit board (PCB) mounted under the electronic module and having a first conductive trace;
an outer shell shielding the electronic module and the housing; wherein
the electronic module has a first ground trace connecting to the outer shell through the first conductive trace of the horizontal PCB.

2. An electrical connector as claimed in claim 1, wherein the electronic module comprises: a first vertical PCB perpendicular to the front face and having a conductive trace; a first plurality of mating contacts mounted on the first vertical PCB and extending into said first mating cavity; and a first plurality of conductors electrically connecting the vertical PCB and the horizontal PCB, the first ground trace comprising the conductive trace of the first vertical PCB and one of said first plurality of conductors.

3. An electrical connector as claimed in claim 2, wherein the horizontal PCB defines a conductive through hole electrically connecting the first conductive trace of horizontal PCB, and the outer shell has a conductive pin extending into the conductive through hole and being electrically connected therein.

4. An electrical connector as claimed in claim 3, wherein the outer shell has a rear wall, said conductive pin extending downwardly from said rear wall, and the horizontal PCB has a protrusion portion extending rearward, said conductive through hole being disposed in the protrusion and aligned with the rear wall of the outer shell in a vertical direction.

5. An electrical connector as claimed in claim 2, wherein the housing defines a second recessed mating cavity stacked below the first mating cavity, and wherein
the electronic module further comprises: a second vertical PCB parallel to the first vertical PCB; a second plurality of mating contacts mounted on the second vertical PCB and extending into said second mating cavity; a second plurality of conductors electrically connecting the second vertical PCB and the horizontal PCB; and wherein
the electronic module has a second ground trace electrically connecting the outer shell through one of said second plurality of conductors and a second conductive trace of the horizontal PCB, the second ground trace comprising a conductive trace of the second vertical PCB and one of the second plurality of conductors.

6. An electrical connector as claimed in claim 2, wherein the electronic module further comprises a capacitor having a pole electrically connected to the first ground trace.

7. An electrical connector as claimed in claim 1, further comprising an indicating device, and wherein the indicating device comprises a light emitting device mounted behind the electronic module and inside the outer shell.

8. An electrical connector as claimed in claim 7, wherein the indicating device further comprises a light guiding pipe mounted in the housing.

9. An electrical connector comprising:
a housing defining a front face and a first mating cavity recessed rearward from the front face for receiving a modular plug;
an electronic module mounted to the housing;
a horizontal PCB mounted under the electronic module;
an outer shell shielding the electronic module; and wherein
the outer shell has a vertical rear wall and a tab extending downwardly from the rear wall, the horizontal PCB having a protrusion portion extending rearward below the vertical rear wall, said tab electrically connecting the protrusion portion of the horizontal PCB.

10. An electrical connector as claimed in claim 9, wherein the horizontal PCB has a first conductive trace and the electronic module has a first ground trace connecting to the outer shell through the first conductive trace of the horizontal PCB and the tab of the outer shell.

11. An electrical connector as claimed in claim 10, wherein the horizontal PCB defines a conductive through hole electrically connecting the first ground trace of horizontal PCB, the tab extending into the conductive through hole and being electrically connected therein.

12. An electrical connector as claimed in claim 11, wherein the electronic module comprises a first vertical PCB perpendicular to the front face, a first plurality of mating contacts mounted on the vertical PCB and extending into said first mating cavity, and a first plurality of conductors electrically connecting the first vertical PCB and the horizontal PCB.

13. An electrical connector as claimed in claim 10, further comprising an indicating device, and wherein the indicating device comprises a light emitting device mounted on the horizontal PCB and inside the outer shell.

14. An electrical connector as claimed in claim 13, wherein the indicating device further comprises a light guiding pipe mounted in the housing.

15. An electrical connector assembly comprising:
a plurality of two-story connection ports side by side located with one another in a longitudinal direction;
each of said two-story connection ports including an electronic module having a pair of vertical printed circuit boards each extending in a front-to-back direction, and a pair of modular jack interfaces essentially located in front of said pair of vertical printed circuit boards and stacked with each other in a mirror image between the pair of vertical printed circuit boards, a support located between and aligned with the pair of vertical printed circuit boards in said longitudinal direction, each of modular jack interfaces including terminals linked to a front edge region of the corresponding vertical printed circuit board, a plurality of conductors located at a lower edge region of each of the corresponding vertical printed circuit board;
a plurality of horizontal printed circuit boards located under said two-story connection ports under condition that each of said horizontal printed circuit boards extends in the longitudinal direction corresponding to at least two neighboring connection ports so as to allow the conductors extend downwardly therethrough; wherein
the whole electrical connector assembly is adapted to be mounted to a mother board to have the conductors extend through the mother board.

16. The electrical connector assembly as claimed in claim 15, wherein said connection ports are unified via an insulative housing which is further enclosed by a metallic shell, and a grounding path is formed from the vertical printed circuit board, the conductors, the horizontal printed circuit board, and the shell.

17. The electrical connector assembly as claimed in claim 16, wherein the shell including a plurality of conductive pins at a bottom edge to extend into the corresponding horizontal printed circuit board for implementation of said grounding path.

18. The electrical connector assembly as claimed in claim 16, wherein a rear edge of each of said vertical printed circuit boards is located in front of a rear edge of the corresponding horizontal printed circuit board above which said vertical printed circuit board is located.
